(19) United States
(12) Patent Application Publication
(10) Pub. No.: US 2010/0229457 A1
(43) Pub. Date: Sep. 16, 2010

(54) Fish magnet portable FAD (Fish Aggregating Device)

(76) Inventor: William Roger Cook, Albemarle, NC (US)

Correspondence Address: William R. Cook, 24163 Endy Rd., Albemarle, NC, 28001, US

(21) Appl. No.: 12/381,244

(22) Filed: Mar. 11, 2009

(51) Int. Cl. A01K 97/02

(52) U.S. Cl. 43/44.99

(57) ABSTRACT

A panel of fabric, 40 sq. ft. or more in size, held in shape by a floating collapsible frame that is easily and quickly assembled and disassembled, for the purpose of aggregating free-swimming gamefish into the immediate area of the invention. The invention collapses into a very small package, so that one or more can be easily stored and transported on a boat. The device also incorporates a chum bag underneath to enhance the fish attracting properties by first attracting bait. It is designed to be free-floating or attached to a drifting or anchored boat, thereby bringing gamefish within casting distance. No existing FAD is portable and compact, as they are pre-assembled or made for permanent deployment.

### BACKGROUND OF THE INVENTION

Saltwater anglers carry objects in their boat; doors, plywood sheets, cardboard and foam sheets, etc., to place on the surface of the water for the purpose of aggregating Dolphin (Mahi Mahi ), Cobia, and other fish which are attracted to surface structure. The drawback to this is the size of the items, which to be effective should be 30 or 40 sq. ft., takes up too much room to make it practical to carry on any but the largest boats, and even on those it is inconvenient. Prior art does not offer an FAD that represents such a large floating object yet disassembles and collapses, without the use of tools, in less than 5 minutes time, into a package 6″ in diameter by 42″ long and weighing less than 6 lbs.

The solution, then, is this device, which will cover enough square footage of water to provide shade and structure for those fish that are attracted to same, yet can be collapsed into a small enough package to allow it to be stored and carried in any size boat without being inconvenient or dangerous. The device must also be quickly and easily assembled and disassembled, so as not to detract from fishing time. It can be deployed upon reaching the fishing grounds and retrieved at the end of the day, ready to go again. The chum bag on the underside of the device enhances the ability to attract fish, as not only will they fixate on the shade and structure, the chum will attract bait, which will hold the game fish at the device.

After testing the device, it appears that it will be useful also in attracting fish that do not normally key on surface structure, such as Spanish Mackerel and Little Tunny. Baitfish such as bay anchovies and glass minnows, which are primary forage species for Spanish Mackerel and Little Tunny, are attracted to the chum and the structure, which they use as shelter, thereby attracting the game fish.

### BRIEF SUMMARY OF THE INVENTION

The Fish Magnet Portable FAD consists of a sheet of ripstop nylon, reinforced polyethylene, canvas, or other material, approximately 6′×8′, or 8′×10′, although dimensions may be varied according to conditions. The fabric sheet is held flat by a framework of plastic, fiberglass, aluminum, or other non-corrosive tubing, in approximate 3½′ sections connected by shock cording for ease of assembly and disassembly.

The framework consists of two separate poles, joined together in the center so as to pivot and form an X shape, and attached to the center of the fabric sheet. The poles each separate into three parts joined by shock cord and each end section folds inward to lie parallel to the center section for compactness. When assembled the frame reaches from corner to corner in an X shape. Each corner of the fabric is attached to the ends of the poles by an “S” hook attached to shock cording, which is attached to the corner of the fabric. The shock cording provides tension to hold the X-frame in place. Foam flotation is attached to the outboard ends of the X-frame to float the device with the fabric sheet body slightly under water. A mount is provided near the center of the X-frame for a vertical 5′ pole, in two parts, with a highly visible flag so the device can be seen from a distance. An opening is provided in the fabric sheet body near the center to allow for attachment of a chum bag. The draw-string of the chum bag is inserted through the opening from the bottom of the fabric body, and is attached to the frame with a rubber band and a short length of hook and loop fastener (Velcro), allowing the chum bag to hang beneath the device and dispense chum, which can be ground-up fish, fish oil, dry pet food soaked with fish oil, or canned pet food. The rubber band allows the chum bag to break away from the FAD in the event that a shark bites the chum bag, to prevent potential loss of the FAD.

Many saltwater gamefish and baitfish are attracted to structure provided by floating objects. Dolphin (Mahi Mahi) have been found in large groups under an object as small as a 2″×4″ wooden stud. Wahoo also frequent floating objects, as do Cobia and Tripletail. Baitfish are also attracted to chum. The structure and shelter provided by the FAD, combined with the chum, will attract baitfish. Gamefish will be attracted to both the structure of the FAD and the baitfish which are present. The device may be deployed in areas where fish are present but scattered and will cause the gamefish to concentrate in the immediate area of the device, allowing anglers to more easily locate and catch the fish. The device will be especially helpful to fly-fishers, who will be able to see the fish and cast to them. The FAD will provide, in its smallest size, at least 40 sq. ft. of surface structure, yet can be collapsed and rolled into a small package, 6″ in diameter by 42″ long, weighing less than 6 lbs., which is easily stored and transported in a boat.

### BRIEF DESCRIPTION OF THE SEVERAL VIEWS OF THE DRAWING

FIG. 1—Top view of the Fish Magnet Portable FAD

All components are labeled on drawing

FIG. 2—Side view of the Fish Magnet Portable FAD

All components are labeled on drawing

### DETAILED DESCRIPTION OF THE INVENTION

### The Fish Magnet Portable FAD Consists of:

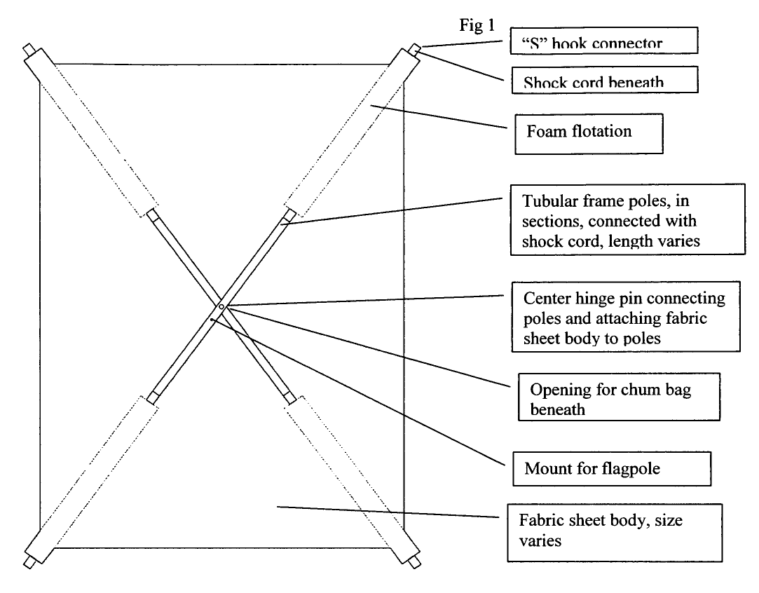

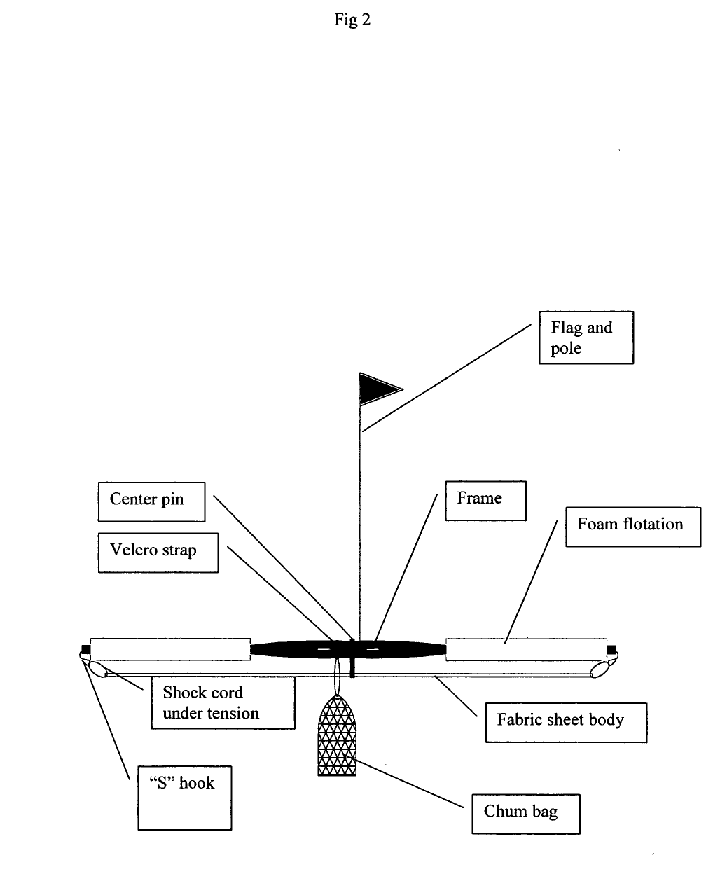

Fabric sheet body (see FIGS. 1 and 2) fabric is nylon, reinforced polyethylene, canvas, or other. Sheet has one grommet in each corner to allow for the attachment of an “s” hook (see FIG. 2) by a loop of shock cord (see FIG. 2) for the purpose of connecting the fabric body to the collapsible frame (see FIGS. 1 and 2) by hooking the “s” hook to the end of the pole. A grommet is located in the center of the sheet to allow fastening the two frame poles (see FIGS. 1 and 2) together and attaching the frame poles to the sheet with a ¼″ bolt, nut, and washers (see FIG. 2). Another grommet is located 2″ from the center grommet on a line with the center grommet and a corner grommet, to provide an opening for the drawstring of the chum bag (see FIG. 2).

Two poles comprising frame are each in three pieces for disassembly and folding for compactness. The poles are made from plastic, fiberglass, aluminum, or other non-corrosive material. The pole sections are connected by shock cord under tension for ease of assembly. The two poles are joined in the center and to the sheet by a ¼″ bolt, nut, and washers. When assembled, the two poles form a “X” frame (see FIG. 1) to spread the sheet to its fullest extent. Flotation (see FIGS. 1 and 2) is attached to the outboard sections of each pole.

When disassembled the outboard ends of the pole fold to lie parallel to the center section, both poles are aligned, and the sheet is folded and rolled around the poles to create a compact package that is easily stored and transported. A device of 40 sq. ft. will compact to a package 6″ in diameter by 42″ long.

A highly visible flag on a 5′, two section pole, normally of fiberglass (see FIG. 2), is inserted into a hole drilled in one of the frame poles, app. two inches from the center pin to allow the device to be seen from a greater distance.

A chum bag hangs from one pole through a grommet in the fabric sheet and is filled with chum to attract bait, which in turn attracts game fish. Many salt water game fish are attracted to floating structure alone, and with the bait attracted by the chum, other fish that do not key on floating structure are attracted by the presence of bait. The chum bag is attached by a rubber band held in place by a hook and loop (Velcro) strip (see FIG. 2) placed around one of the poles. This provision is to prevent the possibility of losing the FAD from a shark biting the chum bag, in which case the rubber band will break before the FAD can be carried away or pulled under the water.

The device floats with the fabric body below the frame, and slightly under water, preventing the possibility of the wind overturning the device.

The Fish Magnet Portable FAD is unlike any existing FAD, in that it collapses into a compact package that is easily stored and transported in smaller boats, assembles in under three minutes into a floating object covering a minimum of 40 sq. ft., and has an integral chum bag to attract bait. At the end of the day, the device can be disassembled and stowed away in under 5 minutes. Existing FAD's are too bulky to be portable, and most are intended for permanent deployment underwater.

The Fish Magnet Portable FAD is designed to be carried in a boat to a fishing location, while using a minimum of limited storage space, and deployed in an area where there are species of fish that are attracted to floating objects. These species include: Dolphin, Wahoo, Billfish, Cobia, Tripletail, and others. The device can also be used in areas where forage species such as Bay Anchovies and Glass Minnows are found. These species feed on the chum deployed and use the device for shelter. When they shelter under the device, species that feed on them will be attracted, even though these species do not key on floating objects. The device may be free-floating, with the angler trolling around it or casting to the fish that are attracted, or tethered to a drifting or anchored boat, bringing the fish within casting distance.

What is claimed:

1. A portable, floating fish aggregating device comprised of:
A sheet fabric body made of nylon, reinforced polyethylene, canvas or other fabric;
A collapsible, folding, pipe frame, in the form of an “X” made of aluminum, plastic, fiberglass, or other non-corrosive tubing, in approximate 3½′ sections connected with shock cord for ease of assembly and disassembly;
A highly visible flag on a 5′, two piece, pole, standing vertically from the “X” frame to aid in seeing the device from a distance;
A chum bag below the fabric sheet body, attached to the “X” frame by a rubber band secured by a strip of hook and loop material (Velcro), to dispense chum (ground-up fish, fish oil, dry pet food soaked with fish oil, or canned pet food.) which attracts smaller baitfish, which in turn attract larger baitfish and game fish.

2. The portable, floating fish aggregating device of claim 1, is portable in that a device measuring 40 sq. ft. will collapse to a package of 6″×42″, weighing less than 6 lbs., making it compact enough to stow and carry one or more in a boat with minimal storage area.

3. The portable, floating fish aggregating device of claim 1, can be assembled, without the use of tools, from a package measuring 6″×42″ into a floating object a minimum of 40 sq. ft. in 3 minutes time, and collapsed, disassembled, and stowed away in under 5 minutes at the end of the day.
